(19) United States
(12) Patent Application Publication
(10) Pub. No.: US 2008/0183549 A1
(43) Pub. Date: Jul. 31, 2008

(54) SYSTEM AND METHOD FOR OVERCOMING INFEASIBILITY DETERMINATIONS IN USING CONSTRAINT SATISFACTION PROGRAMMING FOR SCHEDULING HUMAN RESOURCES

(76) Inventors: Daniel Patrick CONNORS, Pleasant Valley, NY (US); John Peter Fasano, Briarcliff Manor, NY (US); Donna Leigh Gresh, Cortlandt Manor, NY (US); Yehuda Naveh, Haifa (IL)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/057,898

(22) Filed: Mar. 28, 2008

Related U.S. Application Data
(63) Continuation of application No. 11/191,080, filed on Jul. 28, 2005.

(51) Int. Cl. G06Q 10/00

(52) U.S. Cl. 705/9

(57) ABSTRACT

A system and method are disclosed for allocating human resources to tasks using constraint satisfaction programming, where fictitious persons are used to satisfy required constraints, to ensure that the solution process continues until a solution is found, and capability constraints and job constraints are relaxed until a solution is found. Tasks using fictitious persons are identified, and information about task capability requirements not met and capabilities of unallocated human resources are displayed so that constraints may be relaxed and fictitious persons removed. There is provision for handling multi-task jobs where if a fictitious person is assigned to any task then all tasks will be assigned a fictitious person.

### BACKGROUND OF THE INVENTION

1. Field of the Invention

The present invention generally relates to automated tools for scheduling human resources for engagements and, in particular, use of constraint satisfaction techniques in such tools.

2. Background Description

Constraint satisfaction programming has been used in numerous scheduling applications. However, there is a need to find a feasible solution to the problem of scheduling human resources to engagements. For example, one might specify that it is necessary to have either a java architect of band 7 or higher OR a java programmer of band 8 or higher with project management experience, etc. There may be constraints on availability in a particular time frame, or the ability to work well with other members of the team. There may be constraints that depend on one another in any number of complicated relationships. In some cases, the combination of supply of employees and demand for employees may be infeasible. In addition, in some cases one may specify that one needs two employees of type A, one of type B, and four of type C, in order for the job to be done at all.

In standard constraint satisfaction programming the solution stops upon discovery of infeasibility. What is needed is a method for continuing the solution after infeasibility has been discovered.

### SUMMARY OF THE INVENTION

It is therefore an object of the present invention to provide a method for allowing constraint satisfaction techniques for assigning human resources to engagements to continue to be used after infeasibility has been discovered.

The technique of the invention determines the source of the infeasibility and suggests feasible alternatives. This is in contrast to standard constraint satisfaction programming, in which the solution stops upon discovery of infeasibility. One aspect of this technique is the ability to identify those constraints which lead to infeasibility, and then use constraint relaxation techniques. Another aspect is application of the method to multi-task jobs where all resources must be available for any to be useful. Standard constraint satisfaction programming does not provide a methodology for solution in such circumstances.

In one implementation of the invention, human resources are allocated to tasks using constraint satisfaction programming by establishing a database structure for representing tasks and persons available for the tasks. Each task defines an instance of a person type required for performance of the task, and a set of capability constraints is associated with each required person type. One or more tasks comprises a job, and a set of job constraints is associated with each job. A fictitious person for each type of required constraint (e.g. PERSON_NOT_FOUND and PERSON_ALREADY_ASSIGNED) is included in the database. Then a constraint satisfaction program determines an allocation of persons to tasks, allocating a fictitious person to a task if no person meeting the associated set of capability constraints is available within the job constraints applicable to the task. A PERSON_NOT_FOUND is allocated if no suitable person is found, and PERSON_ALREADY_ASSIGNED is allocated if the suitable person is already allocated to another task.

Then an output from the determination is displayed to the user. The output identifies tasks allocated a fictitious person. The user evaluates the output and designates a capability constraint or a job constraint to be relaxed, and then the determination of the constraint satisfaction program is repeated. In a variation on this method, where there is a multi-task job, an exclusivity constraint is added to each task in the multi-task job. This exclusivity constraint requires allocation of a fictitious person to all tasks in the job if a fictitious person has been assigned to any task. Another variation on this method permits the user to designate a multi-task job for removal when a fictitious person has been allocated to any task in the multi-task job.

In a further aspect of the invention, the output can include a listing of capability constraints for each task displayed, the listing being displayed in a separate window for a task selected by the user. There may also be displayed a listing of job constraints for each task displayed, and the listing could be displayed in a printed report sorted by task. Alternatively, the constraints could be shown in a separate window for a task selected by the user. The output can also include in a separate window a listing of persons not allocated, with a further window for displaying the capabilities of a person selected in the separate window by the user. The output can also include a list of persons not allocated for comparison to each fictitious person allocated, showing a metric for each capability constraint and a metric for the corresponding capability of each persons not allocated.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram showing a preferred implementation of the invention.

### DETAILED DESCRIPTION OF A PREFERRED EMBODIMENT OF THE INVENTION

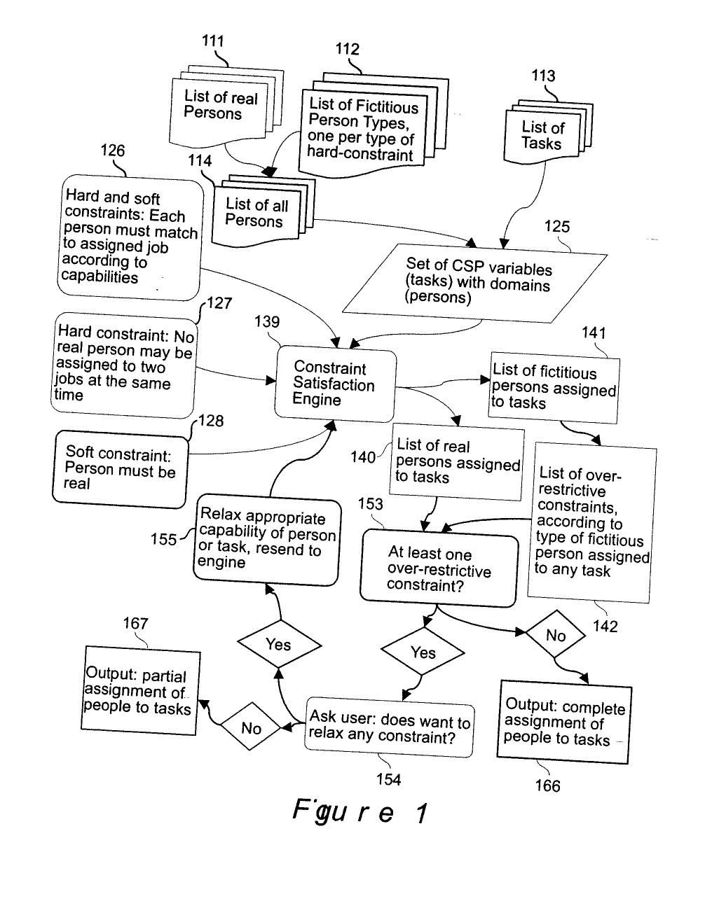

Operation of the invention may be understood with reference to FIG. 1. A list of real persons 111 available for assignment is combined with a list of fictitious person types 112, one for each type of a required constraint. This combination is a list of all persons 114, which is then applied together with a list of tasks 113 to a set of constraint satisfaction problem (CSP) variables 125. The CSP variables 125 are tasks having persons as domains.

The CSP variables 125 form a set of equations to be resolved by a constraint satisfaction engine 139 that takes account of constraints upon the person domains of the CSP variables 125. Each person assigned from the list of persons 114 must have the capabilities required by the task. This type of constraint 126 has some flexibility, because it is a soft constraint in the sense that the capabilities required by the task may be relaxed, but it is also a hard constraint in the sense that it must be met, at least in relaxed form, for the task to be performed. Expressed in another way, it is a hard constraint that a person of a particular type is required for the task, but the capabilities required by the task may be viewed as soft constraints. The hard constraint cannot be relaxed, and therefore is a type of required constraint. Also, the requirement that no real person may be assigned to two tasks at the same time is a type of hard constraint 127 that cannot be relaxed, and is therefore another type of required constraint. Note that this constraint applies to real persons but not to fictitious persons. Soft constraints 128 are those that can be relaxed, such as the requirement that a person required for a task be a real person.

The constraint satisfaction engine 139 operates with the list of all persons 114, under the various constraints 126, 127 and 128, to resolve the CSP variables 125. The output of the constraint satisfaction engine 139 is a list 140 of real persons assigned to tasks 113 and a list 141 of fictitious persons assigned to tasks 113. From the list 141 of fictitious persons assigned to tasks 113 there is generated a list 142 of over-restrictive constraints according to type of fictitious person assigned to any task. A constraint is over-restrictive, as that term is used in the invention, if it cannot be satisfied with an available real person. Each task will then be evaluated 153 in terms of the list 140 of real persons assigned and the list 142 of over-restrictive constraints.

If the solution does not have at least one over-restrictive constraint then the output of the constraint satisfaction engine 139 is complete and the people identified in the solution are assigned 166 to their designated tasks. If the solution has at least one over-restrictive constraint then the user is asked 154 whether any constraint is to be relaxed.

At this point the invention provides lists and displays to help the user determine whether any constraint is to be relaxed. The user can examine the list of over-restrictive constraints 142 and determine whether to relax one of these direct causes of infeasibility. Or the user can display all the constraints in the original problem and undertake a strategy for reaching a solution by relaxing any constraint in the original problem, not simply a constraint identified as a direct cause of infeasibility.

The list of real persons 140 assigned to tasks can be annotated with the capabilities and attributes required by the respective task. The list of constraints 142 requiring assignment of fictitious persons can be annotated to show the capabilities and attributes required by the respective task, and can be sorted according to the type of fictitious person assigned. In addition, a list of persons not assigned to tasks is also available to the user of the invention, and by selecting a particular person on this list a further list of the selected person's capabilities is also available. A similar display sequence can be provided for jobs and the constraints associated with jobs. Furthermore, displays can be provided showing for each fictitious person assigned a list of persons meeting some but not all of the capability constraints, the list being annotated to compare the capabilities of the person with the capabilities required by the constraints. This comparative list may be further annotated by a metric display reflecting a numerical scale used to evaluate each capability constraint and the corresponding capability of each person available for assignment. Such a display of metrics can provide the user with an indication of how far capability constraints would need to be relaxed in order to be met by available personnel.

As will be understood by those skilled in the art, these lists may be arranged in a convenient logical hierarchy and displayed using multiple windows on a display device in accordance with a mechanism for allowing a user to navigate through the hierarchy.

If the user relaxes 155 a required capability of a person or job, the process returns to the constraint satisfaction engine 139 which is run again, generating another list of real persons 140 and another list of fictitious persons 141. The user has the flexibility to do all of the following: a) relax an “over-restrictive” constraint, b) relax a required capability of any person or job, in addition to those assigned to fictitious persons, and c) “relax” an entire task or job by removing it entirely. This ultimately results in a complete assignment of people to tasks 166, or a further request to the user 154 to consider relaxing a constraint. This cycle may be repeated so long as the user is willing to relax a constraint, or until a complete and feasible solution is found. If the user does not want to relax a constraint then a partial assignment of people to tasks is output 167 and the process stops.

In the prior art there are no fictitious persons assignable, and the process terminates if there is no feasible solution. In that event the prior art user is provided with no assistance in identifying how a solution may be obtained by revising one or more constraints. The present invention enables the user to examine a list of those constraints requiring assignment of a fictitious person, and to repeatedly cycle through the process after changing a constraint, to see whether any change will result in a solution. Once a complete and feasible solution to the problem is found, this is the final solution. Of course, the user can then change the original constraints in order to specify a somewhat different problem, and explore the solutions for this new problem. In particular, if the user is not satisfied with some aspect of the original solution found, they may easily add a constraint that eliminates this aspect, and re-run the process. Lastly, if the process found that the original problem was infeasible, and the engine returned the direct-causes for infeasibility, and the user subsequently relaxed some constraint, they may later re-run the same original problem, reach exactly the same point of infeasibility, and then relax a different constraint.

As shown above, the method of the invention is two-fold: first, ‘soft constraints’ are handled by a process of relaxation; second, ‘hard constraints’ that cannot be relaxed are handled by assignment of a ‘fictitious person’. Priorities and preferences can be included using the mechanism of ‘soft constraints, which the CSP engine knows how to handle correctly. That is, for each priority or preference, the user adds a soft constraint specifying that it's better to have a solution with the higher priority or preference, and then the engine will try to satisfy this ‘soft’ requirement, and should provide the solution which best satisfies those priority constraints. The ‘fictitious person’ mechanism handles the ‘hard constraints’, that is, those constraints which must be formally satisfied by the engine. Under the prior art, if any of those hard constraints cannot be satisfied, then the engine will ordinarily fail without a solution.

Thus the invention creates fictitious persons so that these ‘hard constraints’ (required constraints) will always find a person. There is created a PERSON_NOT_FOUND and a PERSON_ALREADY_ASSIGNED. There is a biasing against using these persons, so they won't be assigned as long as there is a suitable ordinary person to assign. However, for example, if the constraint which matches persons to jobs does not find an ordinary person it then matches the person PERSON_NOT_FOUND. Similarly, if the constraint that makes sure that no person is assigned to two jobs finds that two jobs can only be assigned to the same ordinary person, then it assigns to one of the jobs the fictitious person PERSON_ALREADY_ASSIGNED.

Because the constraints can now always find a person (either ordinary or fictitious), they never fail and the engine keeps running until it finds a complete solution. After the solution is returned, infeasible jobs are recognized as the ones that were assigned a fictitious person.

As a consequence of this approach constraints may be applied in a flexible and natural way, including priorities and preferences. For example, a task may optimally require a full time person over a narrow time period between preceding and subsequent tasks within a larger job. Persons available may have preferences for vacation time that conflict with the narrow time period. Or the preference for a full time person may be reasonably accommodated by two persons at half time. In short, the constraints being evaluated by the constraint satisfaction engine 139 may reflect a complex combination of requirements, priorities and preferences. The solution may then be used to identify which constraints are causing infeasibility.

In addition, the invention handles the situation where all resources assigned to a multi-task job become free if any are unavailable. Turning again to FIG. 1, the user is able to relax a capability 155 not only of a person but also of a job or task. For example, in a multi-task job where the constraint satisfaction engine 139 assigned a fictitious person to one of the tasks, one option would be for the user to remove that task, thereby enabling a viable solution for the remaining tasks in the multi-task job. Another alternative would be for the user to add a constraint on each task in the multi-task job requiring that if a fictitious person is assigned to one such task fictitious persons must be assigned to all tasks in the job. This would free the real persons that had been assigned to these tasks in the multi-task job, so that they could be assigned to other engagements. These real persons would also be made available for other engagements if the user removed the entire multi-task job.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for allocating human resources to tasks using constraint satisfaction programming, comprising:
establishing a database structure for representing tasks and persons available for the tasks, each task defining an instance of a person type required for performance of the task, a set of capability constraints being associated with each required person type, one or more tasks comprising a job, and a set of job constraints being associated with each job;
including in the database a fictitious person for each type of required constraint;
determining by a constraint satisfaction program an allocation of persons to tasks, a fictitious person being allocated to a task if no person meeting the associated set of capability constraints is available within the job constraints applicable to the task;
displaying to a user an output from said determination, said output identifying tasks having been allocated a fictitious person; and
receiving from the user a designation of a capability constraint or a job constraint to be relaxed upon repetition of said determination, said designation being based on said display.

2. The method of claim 1, wherein said fictitious person is identified in said display by a type label according to the following rules:
a type label signifying PERSON_NOT_FOUND is used if the constraint satisfaction program fails to find a person meeting the capability constraints associated with the required person type within the job constraints for the task; and
a type label signifying PERSON_ALREADY_ASSIGNED is used if the constraint satisfaction program is unable to allocate a person found meeting the capability constraints associated with the required person type within the job constraints for the task because the person found has already been allocated.

3. The method of claim 1, further comprising adding an exclusivity constraint to each task in a multi-task job, the exclusivity constraint requiring allocation of a fictitious person if a fictitious person has been assigned to any task in the multi-task job.

4. The method of claim 1, further comprising receiving from the user a designation of a multi-task job for removal, said removal option being included in said display when a fictitious person has been allocated to any task in the multi-task job.

5. The method of claim 1, wherein said output includes a listing of capability constraints for each task displayed, said listing being displayed in a separate window for a task selected by the user.

6. The method of claim 5, wherein said output includes a listing of job constraints for each task displayed, said listing being displayed in a printed report sorted by task.

7. The method of claim 5, wherein said output includes a listing of job constraints for each task displayed, said listing being displayed in a separate window for a task selected by the user.

8. The method of claim 1, wherein said output includes a listing of persons not allocated, said listing being displayed in a separate window, there being a further window for displaying the capabilities of a person selected in the separate window by the user.

9. The method of claim 7, wherein the output includes a comparative listing for each fictitious person allocated a list of persons not allocated, the comparative listing showing a metric for each capability constraint and a metric for the corresponding capability for each person not allocated.

10. A system for allocating human resources to tasks using constraint satisfaction programming, comprising:
means for establishing a database structure for representing tasks and persons available for the tasks, each task defining an instance of a person type required for performance of the task, a set of capability constraints being associated with each required person type, one or more tasks comprising a job, and a set of job constraints being associated with each job;
means for including in the database a fictitious person for each type of required constraint;
means for determining by a constraint satisfaction program an allocation of persons to tasks, a fictitious person being allocated to a required instance of a person type if no person meeting the associated set of capability constraints is available within the job constraints;
means for displaying to a user an output from said determination, said output identifying tasks having been allocated a fictitious person; and
means for receiving from the user a designation of a capability constraint or a job constraint to be relaxed upon repetition of said determination, said designation being based on said display.

11. A system as in claim 10, wherein said fictitious person is identified in said display by a type label according to the following rules:
a type label signifying PERSON_NOT_FOUND is used if the constraint satisfaction program fails to find a person meeting the capability constraints associated with the required person type within the job constraints for the task; and
a type label signifying PERSON_ALREADY_ASSIGNED is used if the constraint satisfaction program is unable to allocate a person found meeting the capability constraints associated with the required person type within the job constraints for the task because the person found has already been allocated.

12. A system as in claim 10, further comprising means for adding an exclusivity constraint to each task in a multi-task job, the exclusivity constraint requiring allocation of a fictitious person if a fictitious person has been assigned to any task in the multi-task job.

13. A system as in claim 10, further comprising means for receiving from the user a designation of a multi-task job for removal, said removal option being included in said display when a fictitious person has been allocated to any task in the multi-task job.

14. A system as in claim 10, wherein said output includes a listing of capability constraints for each task displayed, said listing being displayed in a separate window for a task selected by the user.

15. A system as in claim 14, wherein said output includes a listing of job constraints for each task displayed, said listing being displayed in a printed report sorted by task.

16. A system as in claim 14, wherein said output includes a listing of job constraints for each task displayed, said listing being displayed in a separate window for a task selected by the user.

17. A system as in claim 10, wherein said output includes a listing of persons not allocated, said listing being displayed in a separate window, there being a further window for displaying the capabilities of a person selected in the separate window by the user.

18. A system as in claim 16, wherein the output includes a comparative listing for each fictitious person allocated a list of persons not allocated, the comparative listing showing a metric for each capability constraint and a metric for the corresponding capability for each person not allocated.

19. A computer implemented system for allocating human resources to tasks using constraint satisfaction programming, comprising:
first computer code for establishing a database structure for representing tasks and persons available for the tasks, each task defining an instance of a person type required for performance of the task, a set of capability constraints being associated with each required person type, one or more tasks comprising a job, and a set of job constraints being associated with each job;
second computer code for including in the database a fictitious person for each type of required constraint;
third computer code for determining by a constraint satisfaction program an allocation of persons to tasks, a fictitious person being allocated to a required instance of a person type if no person meeting the associated set of capability constraints is available within the job constraints;
fourth computer code for displaying to a user an output from said determination, said output identifying tasks having been allocated a fictitious person; and
fifth computer code for receiving from the user a designation of a capability constraint or a job constraint to be relaxed upon repetition of said determination, said designation being based on said display.

20. A computer implemented system as in claim 19, further comprising sixth computer code for adding an exclusivity constraint to each task in a multi-task job, the exclusivity constraint requiring allocation of a fictitious person if a fictitious person has been assigned to any task in the multi-task job.
